(19) United States
(12) Patent Application Publication
(10) Pub. No.: US 2026/0039580 A1
(43) Pub. Date: Feb. 5, 2026

(54) BORDER GATEWAY PROTOCOL DYNAMIC ADDRESS FAMILY IDENTIFIER AND SUBSEQUENT ADDRESS FAMILY IDENTIFIER CAPABILITY EXCHANGE

(71) Applicant: Juniper Networks, Inc., Sunnyvale, CA (US)

(72) Inventors: Abdul Zubaidhar ABDULLA, Bangalore (IN); Srihari Ramachandra SANGLI, Bengaluru (IN); Abhishek ASTHANA, Bangalore (IN)

(21) Appl. No.: 19/246,940

(22) Filed: Jun. 24, 2025

Related U.S. Application Data
(60) Provisional application No. 63/678,201, filed on Aug. 1, 2024.

(51) Int. Cl. H04L 45/02

(52) U.S. Cl. CPC H04L 45/04

(57) ABSTRACT

In some implementations, a node may generate a first route refresh message that indicates an action request for an address family identifier (AFI) and subsequent address family identifier (SAFI) (AFI/SAFI). The node may send the first route refresh message to another node. The other node may update, based on the action request, a data structure of the other node to indicate that the other node supports or does not support the AFI/SAFI.

### CROSS-REFERENCE TO RELATED APPLICATION

This Patent Application claims priority to India Patent Application No. 63/678,201, filed on Aug. 1, 2024, and entitled “DYNAMIC BORDER GATEWAY PROTOCOL (BGP) ADDRESS FAMILY IDENTIFIER (AFI) AND SUBSEQUENT ADDRESS FAMILY IDENTIFIER (SAFI) EXCHANGE.” The disclosure of the prior Application is considered part of and is incorporated by reference into this Patent Application.

### BACKGROUND

In border gateway protocol (BGP), an address family identifier (AFI) specifies a type of a network protocol (e.g., Internet protocol (IP) version 4 (IPv4) or IP version 6 (IPv6)), while a subsequent address family identifier (SAFI) defines a type of routing information carried for the network protocol (e.g., unicast, multicast, virtual private network (VPN)). Together, AFI and SAFI (referred to herein is AFI/SAFI) support multiple types of address families within a single BGP session.

### SUMMARY

Some implementations described herein relate to a node. The node may include one or more memories and one or more processors. The one or more processors may be configured to generate a first route refresh message associated with a BGP session that includes a message subtype field that indicates an action request for an AFI/SAFI within the BGP session. The one or more processors may be configured to send the first route refresh message to another node.

Some implementations described herein relate to a non-transitory computer-readable medium that stores a set of instructions. The set of instructions, when executed by one or more processors of a node, may cause the node to receive, from another node, a first route refresh message associated with a BGP session that includes a message subtype field that indicates an action request for an AFI/SAFI within the BGP session. The set of instructions, when executed by one or more processors of the node, may cause the node to update, based on the action request, a data structure of the other node to indicate that the other node supports or does not support the AFI/SAFI.

Some implementations described herein relate to a method. The method may include generating, by a node, a first route refresh message that indicates an action request for an AFI/SAFI. The method may include sending, by the node, the first route refresh message to another node.

### BRIEF DESCRIPTION OF THE DRAWINGS

FIG. 1 is a diagram of an example implementation associated with a BGP dynamic AFI/SAFI capability exchange.

FIGS. 2A-2C are diagrams of an example implementation associated with a BGP dynamic AFI/SAFI capability exchange.

FIGS. 3A-3B are diagrams of an example implementation associated with a BGP dynamic AFI/SAFI capability exchange.

FIG. 4 is a diagram of an example environment in which systems and/or methods described herein may be implemented.

FIG. 5 is a diagram of example components of a device associated with a BGP dynamic AFI/SAFI capability exchange.

FIG. 6 is a diagram of example components of a device associated with a BGP dynamic AFI/SAFI capability exchange.

FIG. 7 is a flowchart of an example process associated with a BGP dynamic AFI/SAFI capability exchange.

FIG. 8 is a flowchart of an example process associated with a BGP dynamic AFI/SAFI capability exchange.

FIG. 9 is a flowchart of an example process associated with a BGP dynamic AFI/SAFI capability exchange.

### DETAILED DESCRIPTION

The following detailed description of example implementations refers to the

accompanying drawings. The same reference numbers in different drawings may identify the same or similar elements.

AFI/SAFI negotiation occurs exclusively during an initial message exchange between nodes during establishment of a BGP session. As a result, any AFI/SAFI capability change, such as an addition or a removal of an AFI/SAFI, requires tearing down and re-establishing the BGP session to renegotiate capabilities, also referred to as a session flap. Further, resetting a BGP session causes all previously exchanged routes between the nodes to be withdrawn and then re-advertised, which results in increased network churn, higher utilization of computing resources (e.g., processing resources, memory resources, communication resources, and/or power resources, among other examples) of the nodes, and in some cases, loss of traffic. As the number of services relying on BGP continues to grow, this behavior becomes increasingly disruptive and difficult to manage. There is a clear need for a solution that enables dynamic negotiation of AFI/SAFI, while keeping the BGP session in an established state, in order to improve operational stability and reduce a risk of service impacts.

Some implementations described herein include a node, which is included within a BGP session with another node (e.g., the node and the other node are BGP peers). The node generates a route refresh message that indicates an addition action request for the AFI/SAFI (e.g., to add a new AFI/SAFI to the BGP session) or a deletion action request for the AFI/SAFI (e.g., to remove an AFI/SAFI from the BGP session). In some implementations, the route refresh message includes a message subtype field that indicates the action request for the AFI/SAFI within the BGP session. The node sends the route refresh message to the other node, which informs the other node of the node's updated capability with respect to the AFI/SAFI (e.g., that the node now supports the AFI/SAFI or that the node no longer supports AFI/SAFI). Accordingly, the node and the other node then communicate to support the change to AFI/SAFI capability for the BGP, such as by advertising routes associated with the AFI/SAFI (e.g., the newly supported AFI/SAFI) or by withdrawing routes associated with the AFI/SAFI (e.g., the no longer supported AFI/SAFI).

In this way, some implementations enable a dynamic update of an AFI/SAFI capability of a BGP session. Further, some implementations are backward compatible, ensuring interoperability with existing BGP implementations that do not support the new capabilities described herein, and imposing no impact on existing services, which preserves a stability of ongoing route exchanges and operational behavior of the nodes. In some implementations, the route refresh message is an extended version of the route refresh message defined in International Engineering Task Force (IETF) Request for Comment (RFC) 2918, which facilitates implementation and deployment across a wide range of network environments.

Additionally, some implementations conserve network bandwidth by limiting a scope of information exchanged to only what is necessary for a negotiated AFI/SAFI change. This reduces computing resources (e.g., processing resources, memory resources, communication resources, and/or power resources, among other examples) of participating nodes by minimizing message size and processing logic. Finally, by avoiding full session resets and enabling targeted capability updates, some implementations allow for faster convergence, improving a responsiveness and resilience of a network that includes the nodes.

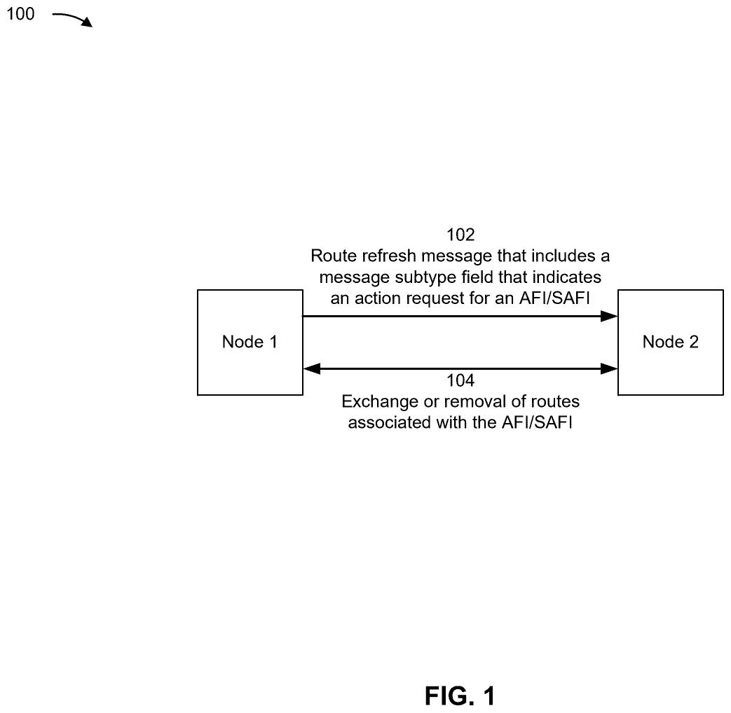

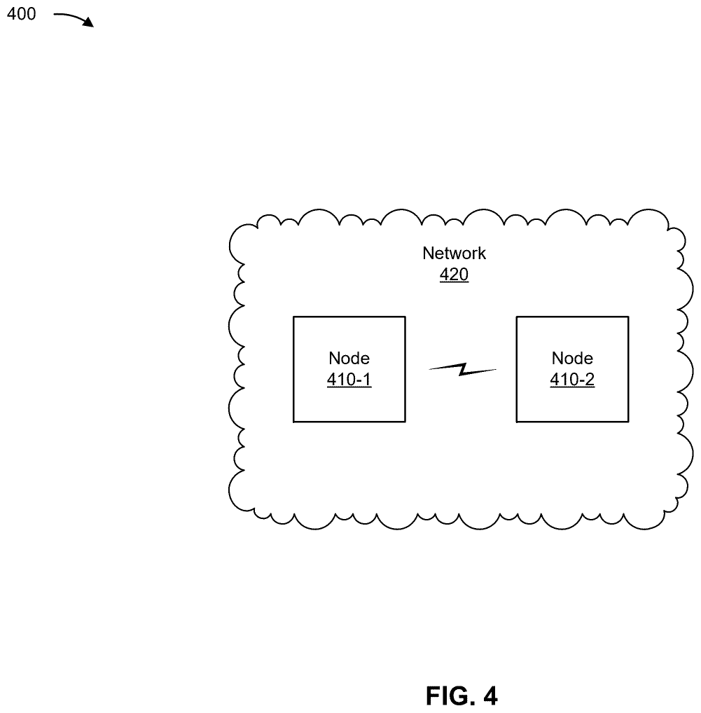

FIG. 1 is a diagram of an example implementation 100 associated with a BGP dynamic AFI/SAFI capability exchange. As shown in FIG. 1, example implementation 100 includes a plurality of nodes, shown as node 1 and node 2. These devices are described in more detail below in connection with FIGS. 4-6.

Node 1 and node 2 are BGP speakers that have a peer-to-peer relationship, such as over a transmission control protocol (TCP) connection. Accordingly, node 1 and node 2 are included within a BGP session. Thus, each node is a BGP peer (or BGP neighbor) to the other, and the nodes exchange routing information according to agreed-upon policies, such as defined by RFC 2918.

As shown in FIG. 1, and by reference number 102, node 1 generates and sends a route refresh message associated with the BGP to node 2. The route refresh message may indicate an action request for an AFI/SAFI within the BGP session. For example, the route refresh message may indicate an addition action request for the AFI/SAFI (e.g., to add a new AFI/SAFI to the BGP session) or a deletion action request for the AFI/SAFI (e.g., to remove an AFI/SAFI from the BGP session). In some implementations, the route refresh message includes a message subtype field that indicates the action request for the AFI/SAFI within the BGP session.

In some implementations, the route refresh message is an extended version of the route refresh message defined in RFC 2918. For example, the route refresh message may include respective fields to identify the AFI/SAFI within the BGP session. Further, a reserved field (e.g., an 8-bit field) of the route refresh message (e.g., as defined by RFC 2918) is redefined as a message subtype field, and may include a value (e.g., a bit value) that indicates the action request for the AFI/SAFI within the BGP session. For example, a value of 5 (0000101) may indicate an addition action request for the AFI/SAFI, and a value of 6 (00000110) may indicate a deletion action request for the AFI/SAFI.

Accordingly, as shown by reference number 104, node 1 and node 2 may communicate messages to facilitate an exchange or removal of routes associated with the AFI/SAFI (e.g., based on the action request for the AFI/SAFI indicated by the route refresh message).

Additional details related to the route refresh message, operations of each node, and communications between the nodes are described elsewhere herein. As indicated above, FIG. 1 is provided as an example. Other examples may differ from what is described with regard to FIG. 1.

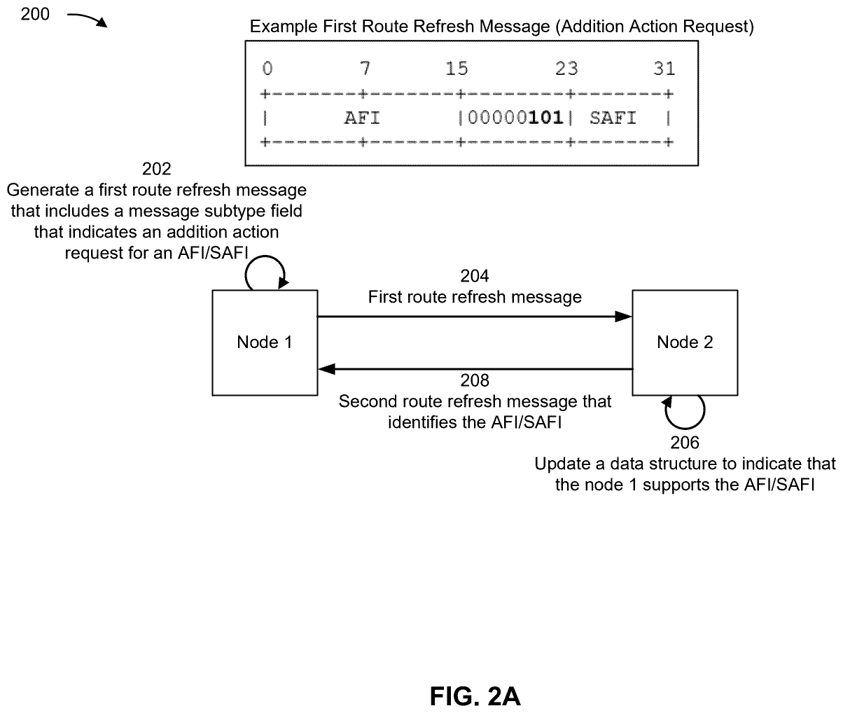

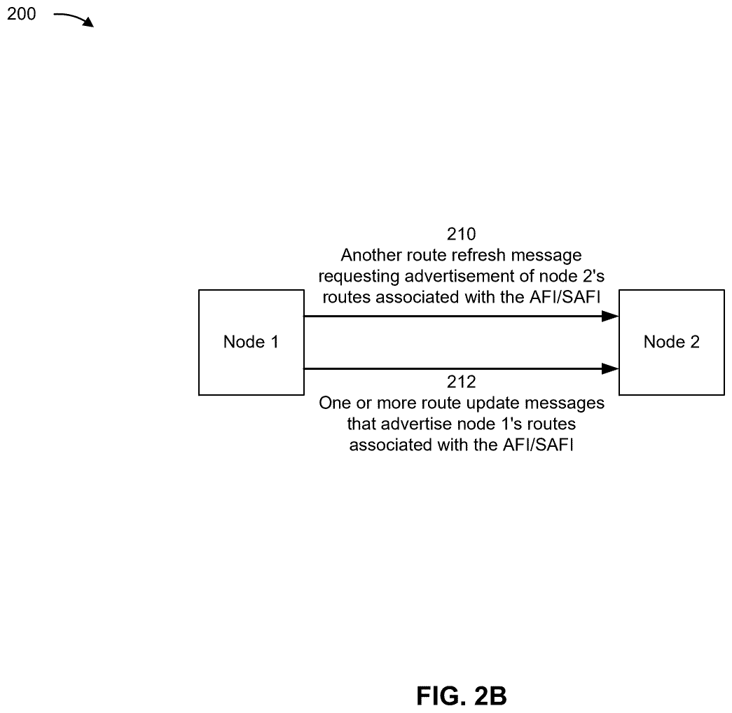

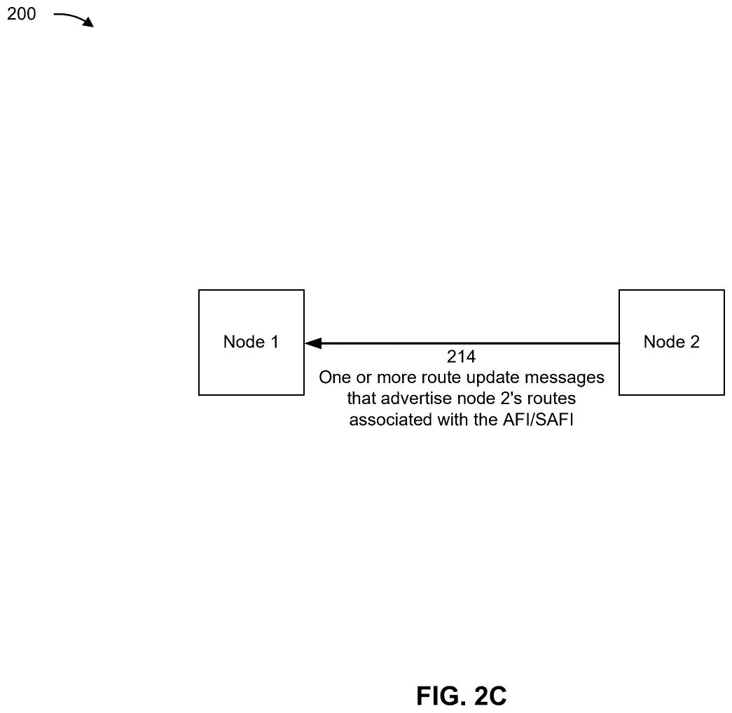

FIGS. 2A-2C are diagrams of an example implementation 200 associated with a BGP dynamic AFI/SAFI capability exchange. As shown in FIGS. 2A-2C, example implementation 200 includes the node 1 and the node 2 described herein in relation to FIG. 1.

As shown in FIG. 2A, and by reference number 202, node 1 generates a first route refresh message. The first route refresh message indicates an addition action request for an AFI/SAFI within the BGP session (e.g., that is established for node 1 and node 2). Node 1 may generate the first route refresh message because node 1 currently supports the AFI/SAFI (and did not previously support the AFI/SAFI within the BGP session). In some implementations, the first route refresh message includes a message subtype field that indicates the addition action request for the AFI/SAFI within the BGP session.

As shown by the example first route refresh message shown in FIG. 2A, which is an extended version of the route refresh message defined in RFC 2918, a message subtype field has a value of 5 (0000101) to indicate an addition action request for the AFI/SAFI identified by other fields of the example first route refresh message.

As shown by reference number 204, node 1 sends the first route refresh message to node 2, and therefore node 2 receives the first route refresh message from node 1. For example, node 1 may send the first route refresh message to node 2 via the BGP session, and node 2 may therefore receive the first route refresh message from node 1 (e.g., via the BGP session).

As shown by reference number 206, node 2 updates a data structure of node 2 to indicate that node 1 supports the AFI/SAFI (e.g., based on the action request). For example, node 2 may process (e.g., parse and/or read) the first route refresh message to determine that the first route refresh message (e.g., the message subtype field of the first route refresh message) indicates an addition action request for the AFI/SAFI, and therefore may update (e.g., based on the addition action request) a data structure of node 2 to indicate that node 1 supports the AFI/SAFI.

As shown by reference number 208, node 2 may send a second route refresh message to node 1, and therefore node 1 may receive the second route refresh message from node 2. For example, node 2 may send the second route refresh message to node 1 via the BGP session, and node 1 may therefore receive the second route refresh message from node 2 (e.g., via the BGP session). In some implementations, the second route message identifies the AFI/SAFI. That is, the second route refresh message may include fields that indicate the AFI/SAFI. In some implementations, the second route refresh message may be a route refresh message as defined by RFC 2918.

Node 2 may send the second route refresh message to node 1 when node 2 currently supports the AFI/SAFI. That is, node 2 may send the second route refresh message to confirm that node 2 also supports the AFI/SAFI (e.g., in addition to node 1 supporting the AFI/SAFI), to confirm that node 2 accepts the addition action request, and that node 2 is ready to exchange routes associated with the AFI/SAFI.

In some implementations, when node 2 does not have a capability to identify the action request indicated by the first route refresh message (e.g., node 2 has not been updated to recognize the message subtype field of the first route refresh message) or when node 2 does not currently support the AFI/SAFI, node 2 may not perform any operations described herein in association with reference numbers 206 and 208. That is, node 2 may receive the first route refresh message and may not perform any operations in response to receiving the first route refresh message.

As shown in FIG. 2B, and by reference number 210, node 1 may send another route refresh message to node 2, and therefore node 2 may receive the other route refresh message from node 1. For example, node 1 may send the other route refresh message to node 2 via the BGP session, and node 2 may therefore receive the other route refresh message from node 1 (e.g., via the BGP session). Node 1 may send the other route refresh message based on (e.g., in response to) receiving the second route refresh message from node 2. The other route refresh message may request advertisement of node 2's routes associated with the AFI/SAFI.

In some implementations, node 1 may forgo sending the other route refresh message to node 2, such as when node 2 is configured to automatically advertise node 2's routes associated with the AFI/SAFI (e.g., in response to receiving the first route refresh message) or when node 2 is actively advertising the routes or has already advertised the routes, such as in a manner described herein in relation to FIG. 2C and reference number 214.

As shown by reference number 212, node 1 may send one or more route update messages to node 2, and therefore node 2 may receive the one or more route update messages from node 1. For example, node 1 may send the one or more route update messages to node 2 via the BGP session, and node 2 may therefore receive the one or more route update messages from node 1 (e.g., via the BGP session). Node 1 may send the one or more route update messages based on (e.g., in response to) receiving the second route refresh message from node 2. The one or more route update messages, which may be formatted in accordance with RFC 4271, may advertise node 1's routes associated with the AFI/SAFI.

As shown in FIG. 2C by reference number 214, node 2 may send one or more route update messages to node 1, and therefore node 1 may receive the one or more route update messages from node 2. For example, node 2 may send the one or more route update messages to node 1 via the BGP session, and node 1 may therefore receive the one or more route update messages from node 2 (e.g., via the BGP session). Node 2 may send the one or more route update messages based on (e.g., in response to) receiving the first route refresh message and/or the other route refresh message from node 1. The one or more route update messages, which may be formatted in accordance with RFC 4271, may advertise node 2's routes associated with the AFI/SAFI.

In this way, as shown in FIGS. 2A-2C, node 1 and node 2 communicate to facilitate a dynamic AFI/SAFI capability (e.g., a new AFI/SAFI capability) exchange.

As indicated above, FIGS. 2A-2C are provided as an example. Other examples may differ from what is described with regard to FIGS. 2A-2C.

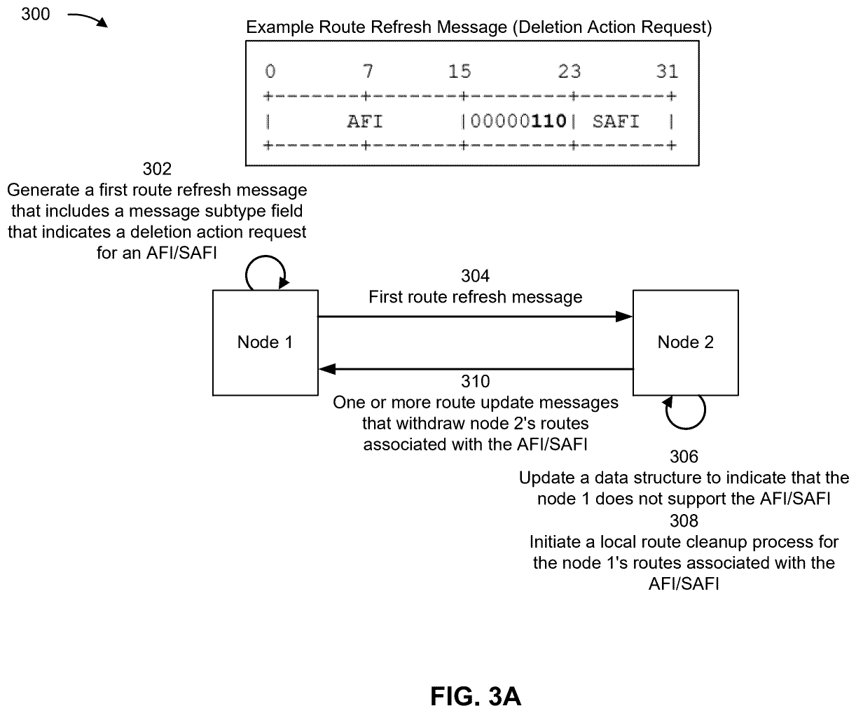

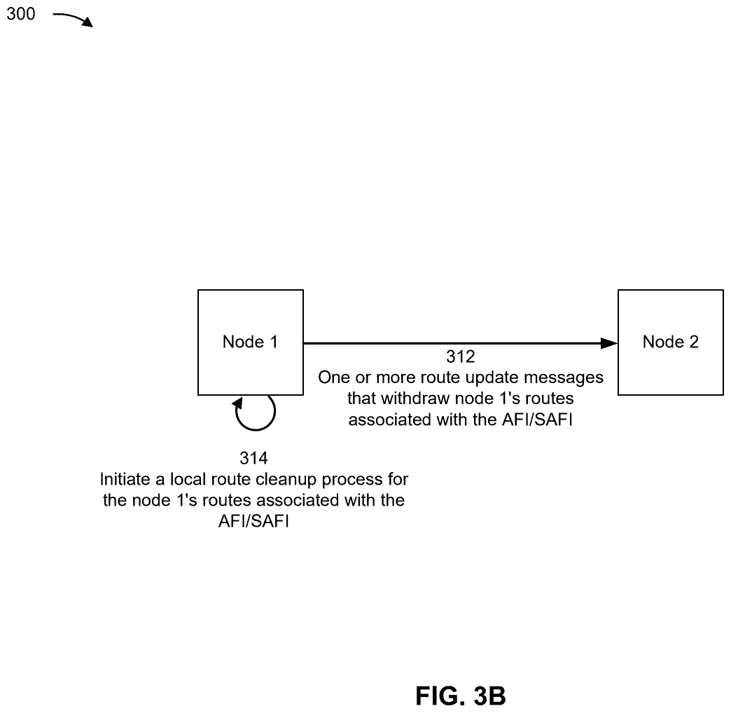

FIGS. 3A-3B are diagrams of an example implementation 300 associated with a BGP dynamic AFI/SAFI capability exchange. As shown in FIGS. 3A-3B, example implementation 300 includes the node 1 and the node 2 described herein in relation to FIGS. 1 and 2A-2C.

As shown in FIG. 3A, and by reference number 302, node 1 generates a first route refresh message. The first route refresh message indicates a deletion action request for an AFI/SAFI within the BGP session (e.g., that is established for node 1 and node 2). Node 1 may generate the first route refresh message because node 1 ceases to support the AFI/SAFI (and previously supported the AFI/SAFI within the BGP session). In some implementations, the first route refresh message includes a message subtype field that indicates the deletion action request for the AFI/SAFI within the BGP session.

As shown by the example first route refresh message shown in FIG. 3A, which is an extended version of the route refresh message defined in RFC 2918, a message subtype field has a value of 6 (0000110) to indicate a deletion action request for the AFI/SAFI identified by other fields of the example first route refresh message.

As shown by reference number 304, node 1 sends the first route refresh message to node 2, and therefore node 2 receives the first route refresh message from node 1. For example, node 1 may send the first route refresh message to node 2 via the BGP session, and node 2 may therefore receive the first route refresh message from node 1 (e.g., via the BGP session).

As shown by reference number 306, node 2 updates a data structure of node 2 to indicate that node 1 does not support the AFI/SAFI (e.g., based on the action request). For example, node 2 may process (e.g., parse and/or read) the first route refresh message to determine that the first route refresh message (e.g., the message subtype field of the first route refresh message) indicates a deletion action request for the AFI/SAFI, and therefore may update (e.g., based on the addition action request) a data structure of node 2 to indicate that node 1 does not support the AFI/SAFI.

As shown by reference number 308, node 2 may initiate a local route cleanup process on node 2 for node 1's routes associated with the AFI/SAFI (e.g., based on the first route refresh message). For example, node 2 may initiate a removal of node 1's routes associated with the AFI/SAFI from a local routing information base (RIB), a local forwarding information base (FIB), or the like, of node 2 based on (e.g., in response to) receiving the first route refresh message. In some implementations, node 2 may also forgo advertising node 2's routes associated with the AFI/SAFI to node 1 (e.g., in response to receiving the first route refresh message). For example, node 2 may suppress sending update messages that advertise node 2's routes associated with the AFI/SAFI to node 1.

As shown by reference number 310, node 2 may send one or more route update messages to node 1, and therefore node 1 may receive the one or more route update messages from node 2. For example, node 2 may send the one or more route update messages to node 1 via the BGP session, and node 1 may therefore receive the one or more route update messages from node 2 (e.g., via the BGP session). Node 2 may send the one or more route update messages based on (e.g., in response to) receiving the first route refresh message. The one or more route update messages, which may be formatted in accordance with RFC 4271, may withdraw node 2's routes associated with the AFI/SAFI.

In some implementations, when node 2 does not have a capability to identify the action request indicated by the first route refresh message (e.g., node 2 has not been updated to recognize the message subtype field of the first route refresh message) or when node 2 does not currently support the AFI/SAFI, node 2 may not perform any operations described herein in association with reference numbers 306, 308, and 310. That is, node 2 may receive the first route refresh message and may not perform any operations in response to receiving the first route refresh message.

As shown in FIG. 3B, and by reference number 312, node 1 may send one or more route update messages to node 2, and therefore node 2 may receive the one or more route update messages from node 1. For example, node 1 may send the one or more route update messages to node 2 via the BGP session, and node 2 may therefore receive the one or more route update messages from node 1 (e.g., via the BGP session). Node 1 may send the one or more route update messages based on sending (e.g., after sending) the first route refresh message to node 2. The one or more route update messages, which may be formatted in accordance with RFC 4271, may withdraw node 1's routes associated with the AFI/SAFI.

As shown by reference number 314, node 1 may initiate a local route cleanup process on node 1 for node 2's routes associated with the AFI/SAFI (e.g., based on sending the first route refresh message). For example, node 1 may initiate a removal of node 2's routes associated with the AFI/SAFI from a local RIB, a local FIB, or the like, of node 1 based on sending (e.g., after sending) the first route refresh message. In some implementations, node 1 may delay initiation of the local route cleanup process (e.g., by one or more seconds) to allow traffic (e.g., that comprises packets) that is in transit and associated with node 2's routes that are associated with the AFI/SAFI to proceed without interruption.

In some implementations, after sending the first route refresh message, node 1 may receive one or more update messages from node 2 that advertise node 2's routes associated with the AFI/SAFI (e.g., prior to node 2 performing any operations described herein in relation to FIG. 3A and reference number 308). Accordingly, node 1 may receive the one or more update messages and may not perform any operations in response to receiving the one or more update messages. In some implementations, because node 1 does not support the AFI/SAFI, node 1 will not cause the BGP session to flap (e.g., that might otherwise occur to include the AFI/SAFI within BGP session), which prevents, or at least reduces, network disruption.

As indicated above, FIGS. 3A-3B are provided as an example. Other examples may differ from what is described with regard to FIGS. 3A-3B.

In some implementations, node 2 may not have a capability to identify the action

request indicated by a first route refresh message that is sent by node 1 (e.g., node 2 may not be updated to recognize the message subtype field of the first route refresh message), as described elsewhere herein in relation to FIGS. 1, 2A-2C, and 3A-3C. Accordingly, node 2 may ignore the message subtype field and may treat the first route refresh message as an unextended version of the route refresh message defined in RFC 2918. Thus, some implementations described herein enable backward compatibility with existing BGP messaging functionalities.

FIG. 4 is a diagram of an example environment 400 in which systems and/or methods described herein may be implemented. As shown in FIG. 4, environment 400 may include a plurality of nodes 410 (shown as node 410-1 and node 410-2) and a network 420. Devices of environment 400 may interconnect via wired connections, wireless connections, or a combination of wired and wireless connections.

Node 410 includes one or more devices capable of receiving, processing, storing, routing, and/or providing traffic (e.g., a payload packet, a file, etc.) in a manner described herein. For example, node 410 may include a router, such as a label switching router (LSR), a label edge router (LER), an ingress router, an egress router, a provider router (e.g., a provider edge router, a provider core router, etc.), a virtual router, or another type of router. Additionally, or alternatively, node 410 may include a gateway, a switch, a firewall, a hub, a bridge, a reverse proxy, a server (e.g., a proxy server, a cloud server, a data center server, etc.), a load balancer, and/or a similar device. In some implementations, node 410 may be a physical device implemented within a housing, such as a chassis. In some implementations, node 410 may be a virtual device implemented by one or more computer devices of a cloud computing environment or a data center.

Network 420 includes one or more wired and/or wireless networks. For example, network 420 may include a cellular network (e.g., a fifth generation (5G) network, a fourth generation (4G) network, such as a long-term evolution (LTE) network, a third generation (3G) network, a code division multiple access (CDMA) network, a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks shown in FIG. 4 are provided as one or more examples. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of environment 400 may perform one or more functions described as being performed by another set of devices of environment 400.

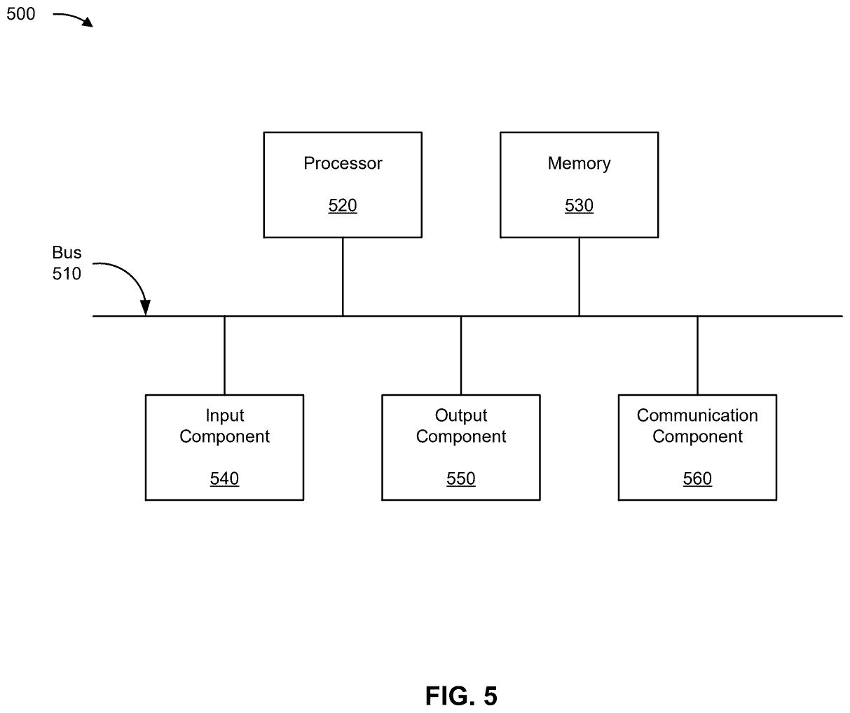

FIG. 5 is a diagram of example components of a device 500 associated with a BGP dynamic AFI/SAFI capability exchange. The device 500 corresponds to node 410. In some implementations, node 410 include one or more devices 500 and/or one or more components of the device 500. In the example shown in FIG. 5, the device 500 includes a bus 510, a processor 520, a memory 530, an input component 540, an output component 550, and/or a communication component 560.

The bus 510 includes one or more components that enable wired and/or wireless communication among the components of the device 500. The bus 510 couples together two or more components of FIG. 5, such as via operative coupling, communicative coupling, electronic coupling, and/or electric coupling. For example, the bus 510 may include an electrical connection (e.g., a wire, a trace, and/or a lead) and/or a wireless bus. The processor 520 includes a central processing unit, a graphics processing unit, a microprocessor, a controller, a microcontroller, a digital signal processor, a field-programmable gate array, an application-specific integrated circuit, and/or another type of processing component. The processor 520 may be implemented in hardware, firmware, or a combination of hardware and software. In some implementations, the processor 520 includes one or more processors capable of being programmed to perform one or more operations or processes described elsewhere herein.

The memory 530 includes volatile and/or nonvolatile memory, such as random access memory (RAM), read only memory (ROM), a hard disk drive, and/or another type of memory (e.g., a flash memory, a magnetic memory, and/or an optical memory). The memory 530 may include internal memory (e.g., RAM, ROM, or a hard disk drive) and/or removable memory (e.g., removable via a universal serial bus connection). In some implementations, the memory 530 is a non-transitory computer-readable medium. The memory 530 stores information, one or more instructions, and/or software (e.g., one or more software applications) related to the operation of the device 500. In some implementations, the memory 530 includes one or more memories that are coupled (e.g., communicatively coupled) to one or more processors (e.g., processor 520), such as via the bus 510. Communicative coupling between a processor 520 and a memory 530 enables the processor 520 to read and/or process information stored in the memory 530 and/or to store information in the memory 530.

The input component 540 enables the device 500 to receive input, such as user input and/or sensed input. For example, the input component 540 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 550 enables the device 500 to provide output, such as via a display, a speaker, and/or a light-emitting diode. The communication component 560 enables the device 500 to communicate with other devices via a wired connection and/or a wireless connection. For example, the communication component 560 may include a receiver, a transmitter, a transceiver, a modem, a network interface card, and/or an antenna.

In some implementations, the device 500 performs one or more operations or processes described herein. For example, a non-transitory computer-readable medium (e.g., memory 530) may store a set of instructions (e.g., one or more instructions or code) for execution by the processor 520. The processor 520 may execute the set of instructions to perform one or more operations or processes described herein. In some implementations, execution of the set of instructions, by one or more processors 520, causes the one or more processors 520 and/or the device 500 to perform one or more operations or processes described herein. In some implementations, hardwired circuitry is used instead of or in combination with the instructions to perform one or more operations or processes described herein. Additionally, or alternatively, the processor 520 may be configured to perform one or more operations or processes described herein. Thus, implementations described herein are not limited to any specific combination of hardware circuitry and software.

The number and arrangement of components shown in FIG. 5 are provided as an example. The device 500 may include additional components, fewer components, different components, or differently arranged components than those shown in FIG. 5. Additionally, or alternatively, a set of components (e.g., one or more components) of the device 500 may perform one or more functions described as being performed by another set of components of the device 500.

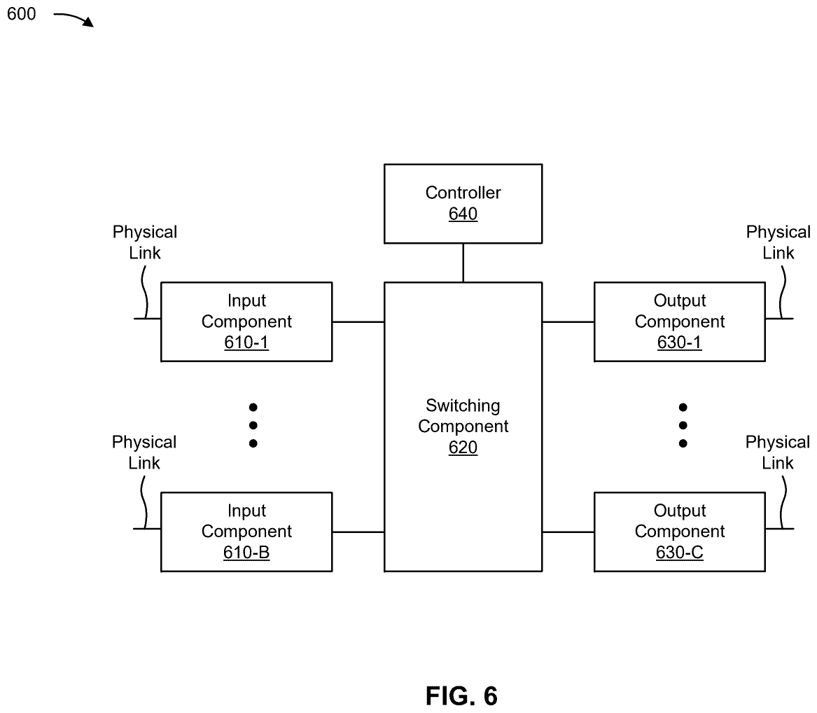

FIG. 6 is a diagram of example components of a device 600 associated with a BGP dynamic AFI/SAFI capability exchange. Device 600 may correspond to node 410. In some implementations, node 410 may include one or more devices 600 and/or one or more components of device 600. As shown in FIG. 6, device 600 may include one or more input components 610-1 through 610-B (B≥1) (hereinafter referred to collectively as input components 610, and individually as input component 610), a switching component 620, one or more output components 630-1 through 630-C (C≥1) (hereinafter referred to collectively as output components 630, and individually as output component 630), and a controller 640.

Input component 610 may be one or more points of attachment for physical links and may be one or more points of entry for incoming traffic, such as packets. Input component 610 may process incoming traffic, such as by performing data link layer encapsulation or decapsulation. In some implementations, input component 610 may transmit and/or receive packets. In some implementations, input component 610 may include an input line card that includes one or more packet processing components (e.g., in the form of integrated circuits), such as one or more interface cards (IFCs), packet forwarding components, line card controller components, input ports, processors, memories, and/or input queues. In some implementations, device 600 may include one or more input components 610.

Switching component 620 may interconnect input components 610 with output components 630. In some implementations, switching component 620 may be implemented via one or more crossbars, via busses, and/or with shared memories. The shared memories may act as temporary buffers to store packets from input components 610 before the packets are eventually scheduled for delivery to output components 630. In some implementations, switching component 620 may enable input components 610, output components 630, and/or controller 640 to communicate with one another.

Output component 630 may store packets and may schedule packets for transmission on output physical links. Output component 630 may support data link layer encapsulation or decapsulation, and/or a variety of higher-level protocols. In some implementations, output component 630 may transmit packets and/or receive packets. In some implementations, output component 630 may include an output line card that includes one or more packet processing components (e.g., in the form of integrated circuits), such as one or more IFCs, packet forwarding components, line card controller components, output ports, processors, memories, and/or output queues. In some implementations, device 600 may include one or more output components 630. In some implementations, input component 610 and output component 630 may be implemented by the same set of components (e.g., and input/output component may be a combination of input component 610 and output component 630).

Controller 640 includes a processor in the form of, for example, a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), and/or another type of processor. The processor is implemented in hardware, firmware, or a combination of hardware and software. In some implementations, controller 640 may include one or more processors that can be programmed to perform a function.

In some implementations, controller 640 may include a RAM, a ROM, and/or another type of dynamic or static storage device (e.g., a flash memory, a magnetic memory, an optical memory, etc.) that stores information and/or instructions for use by controller 640.

In some implementations, controller 640 may communicate with other devices, networks, and/or systems connected to device 600 to exchange information regarding network topology. Controller 640 may create routing tables based on the network topology information, may create forwarding tables based on the routing tables, and may forward the forwarding tables to input components 610 and/or output components 630. Input components 610 and/or output components 630 may use the forwarding tables to perform route lookups for incoming and/or outgoing packets.

Controller 640 may perform one or more processes described herein. Controller 640 may perform these processes in response to executing software instructions stored by a non-transitory computer-readable medium. A computer-readable medium is defined herein as a non-transitory memory device. A memory device includes memory space within a single physical storage device or memory space spread across multiple physical storage devices.

Software instructions may be read into a memory and/or storage component associated with controller 640 from another computer-readable medium or from another device via a communication interface. When executed, software instructions stored in a memory and/or storage component associated with controller 640 may cause controller 640 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 6 are provided as an example. In practice, device 600 may include additional components, fewer components, different components, or differently arranged components than those shown in FIG. 6. Additionally, or alternatively, a set of components (e.g., one or more components) of device 600 may perform one or more functions described as being performed by another set of components of device 600.

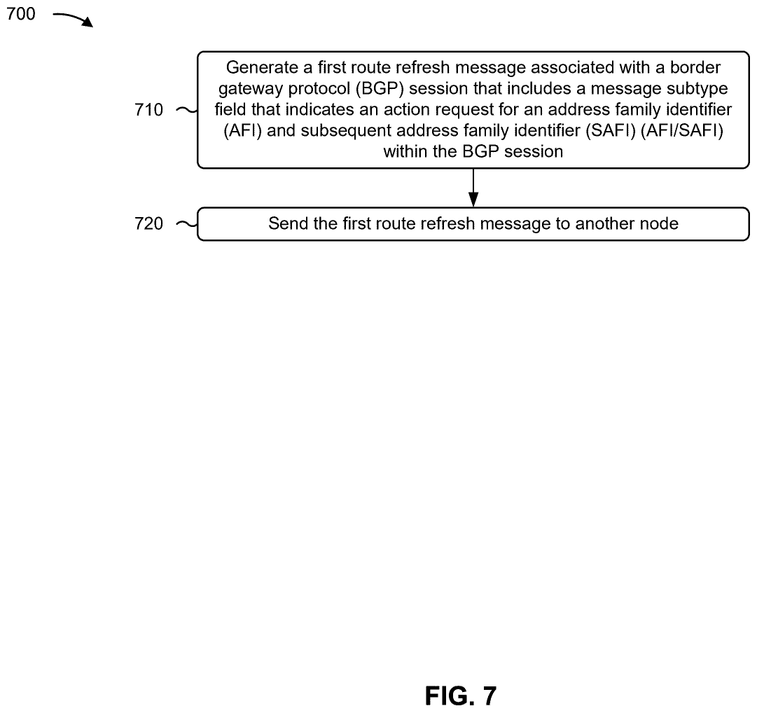

FIG. 7 is a flowchart of an example process 700 associated with a BGP dynamic AFI/SAFI capability exchange. One or more process blocks of FIG. 7 are performed by a node (e.g., node 410-1) and/or by another device or a group of devices separate from or including the node, such as another node (e.g., node 410-2). Additionally, or alternatively, one or more process blocks of FIG. 7 may be performed by one or more components of device 500, such as processor 520, memory 530, input component 540, output component 550, and/or communication component 560; a device 600, such as input component 610, switching component 620, output component 630, and/or controller 640; and/or another device.

As shown in FIG. 7, process 700 includes generating a first route refresh message associated with a BGP session that includes a message subtype field that indicates an AFI/SAFI within the BGP session (block 710). For example, the node may generate a first route refresh message associated with a BGP session that includes a message subtype field that indicates an action request for an AFI/SAFI within the BGP session, as described above.

As further shown in FIG. 7, process 700 includes sending the first route refresh message to another node (block 720). For example, the node may send the first route refresh message to another node, as described above.

Process 700 may include additional aspects, such as any single aspect or any combination of aspects described below and/or in connection with one or more other processes described elsewhere herein.

In a first aspect, the message subtype field indicates an addition action request for the AFI/SAFI, and sending the first route refresh message to the other node is to cause at least one of the other node to update a data structure of the other node to indicate that the node supports the AFI/SAFI, or the other node to send, to the node, a second route refresh message that identifies the AFI/SAFI.

In a second aspect, alone or in combination with the first aspect, the message subtype field indicates an addition action request for the AFI/SAFI, and process 700 includes receiving, from the other node and based on sending the first route refresh message, a second route refresh message that identifies the AFI/SAFI.

In a third aspect, alone or in combination with one or more of the first and second aspects, process 700 includes at least one of sending, to the other node and based on receiving the second route refresh message, another route refresh message requesting advertisement of the other node's routes associated with the AFI/SAFI, or sending, to the other node and based on receiving the second route refresh message, one or more route update messages that advertise the node's routes associated with the AFI/SAFI.

In a fourth aspect, alone or in combination with one or more of the first through third aspects, process 700 includes receiving one or more route update messages that advertise the other node's routes associated with the AFI/SAFI.

In a fifth aspect, alone or in combination with one or more of the first through fourth aspects, the message subtype field indicates a deletion action request for the AFI/SAFI, and sending the first route refresh message to the other node is to cause at least one of the other node to update a data structure of the other node to indicate that the node does not support the AFI/SAFI, the other node to initiate a local route cleanup process on the other node for the node's routes associated with the AFI/SAFI, or the other node to send, to the node, one or more route update messages that withdraw the other node's routes associated with the AFI/SAFI.

In a sixth aspect, alone or in combination with one or more of the first through fifth aspects, the message subtype field indicates a deletion action request for the AFI/SAFI, and process 700 includes sending, to the other node and based on sending the first route refresh message, one or more route update messages that withdraw the node's routes associated with the AFI/SAFI, or initiating, based on sending the first route refresh message, a local route cleanup process on the node for the node's routes associated with the AFI/SAFI.

In a seventh aspect, alone or in combination with one or more of the first through sixth aspects, the message subtype field indicates a deletion action request for the AFI/SAFI, and process 700 includes receiving, from the other node and based on sending the first route refresh message, one or more route update messages that withdraw the other node's routes associated with the AFI/SAFI.

Although FIG. 7 shows example blocks of process 700, in some implementations, process 700 includes additional blocks, fewer blocks, different blocks, or differently arranged blocks than those depicted in FIG. 7. Additionally, or alternatively, two or more of the blocks of process 700 may be performed in parallel.

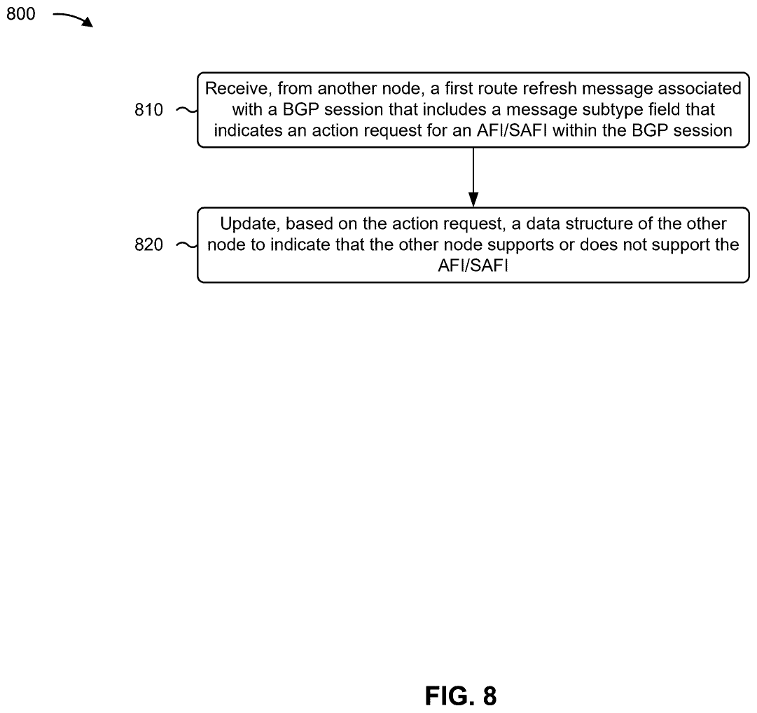

FIG. 8 is a flowchart of an example process 800 associated with a BGP dynamic AFI/SAFI capability exchange. One or more process blocks of FIG. 8 are performed by a node (e.g., node 410-1) and/or by another device or a group of devices separate from or including the node, such as another node (e.g., node 410-2). Additionally, or alternatively, one or more process blocks of FIG. 8 may be performed by one or more components of device 500, such as processor 520, memory 530, input component 540, output component 550, and/or communication component 560; a device 600, such as input component 610, switching component 620, output component 630, and/or controller 640; and/or another device.

As shown in FIG. 8, process 800 includes receiving, from another node, a first route refresh message associated with a BGP session that includes a message subtype field that indicates an action request for an AFI/SAFI within the BGP session (block 810). For example, the node may receive, from another node, a first route refresh message associated with a BGP session that includes a message subtype field that indicates an action request for an AFI/SAFI within the BGP session, as described above.

As further shown in FIG. 8, process 800 includes updating, based on the action request, a data structure of the other node to indicate that the other node supports or does not support the AFI/SAFI (block 820). For example, the node may update, based on the action request, a data structure of the other node to indicate that the other node supports or does not support the AFI/SAFI, as described above.

Process 800 may include additional aspects, such as any single aspect or any combination of aspects described below and/or in connection with one or more other processes described elsewhere herein.

In a first aspect, process 800 includes sending, based on receiving the first route refresh message, a second route refresh message that identifies the AFI/SAFI.

In a second aspect, alone or in combination with the first aspect, process 800 includes sending, to the other node and based on receiving the first route refresh message, one or more route update messages that advertise the node's routes associated with the AFI/SAFI.

In a third aspect, alone or in combination with one or more of the first and second aspects, process 800 includes initiating, based on receiving the first route refresh message, a local route cleanup process on the node for the other node's routes associated with the AFI/SAFI, or sending, to the other node and based on receiving the first route refresh message, one or more route update messages that withdraw the node's routes associated with the AFI/SAFI.

Although FIG. 8 shows example blocks of process 800, in some implementations, process 800 includes additional blocks, fewer blocks, different blocks, or differently arranged blocks than those depicted in FIG. 8. Additionally, or alternatively, two or more of the blocks of process 800 may be performed in parallel.

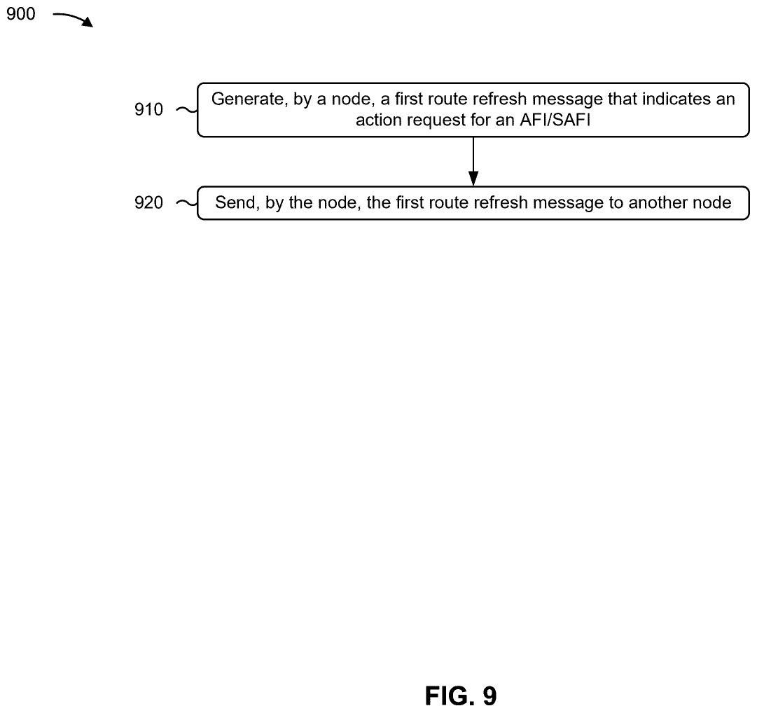

FIG. 9 is a flowchart of an example process 900 associated with a BGP dynamic AFI/SAFI capability exchange. One or more process blocks of FIG. 9 are performed by a node (e.g., node 410-1) and/or by another device or a group of devices separate from or including the node, such as another node (e.g., node 410-2). Additionally, or alternatively, one or more process blocks of FIG. 9 may be performed by one or more components of device 500, such as processor 520, memory 530, input component 540, output component 550, and/or communication component 560; a device 600, such as input component 610, switching component 620, output component 630, and/or controller 640; and/or another device.

As shown in FIG. 9, process 900 includes generating a first route refresh message that indicates an action request for an AFI/SAFI (block 910). For example, the node may generate a first route refresh message that indicates an action request for an AFI/SAFI, as described above.

As further shown in FIG. 9, process 900 includes sending the first route refresh message to another node (block 920). For example, the node may send the first route refresh message to another node, as described above.

Process 900 may include additional aspects, such as any single aspect or any combination of aspects described below and/or in connection with one or more other processes described elsewhere herein.

In a first aspect, sending the first route refresh message to the other node causes at least one of the other node to update a data structure of the other node to indicate that the node supports the AFI/SAFI, or the other node to send, to the node, a second route refresh message that identifies the AFI/SAFI.

In a second aspect, alone or in combination with the first aspect, process 900 includes receiving, from the other node and based on sending the first route refresh message, a second route refresh message that identifies the AFI/SAFI.

In a third aspect, alone or in combination with one or more of the first and second aspects, process 900 includes at least one of sending, to the other node and based on receiving the second route refresh message, another route refresh message requesting advertisement of the other node's routes associated with the AFI/SAFI, or sending, to the other node and based on receiving the second route refresh message, one or more route update messages that advertise the node's routes associated with the AFI/SAFI.

In a fourth aspect, alone or in combination with one or more of the first through third aspects, process 900 includes receiving one or more route update messages that advertise the other node's routes associated with the AFI/SAFI.

In a fifth aspect, alone or in combination with one or more of the first through fourth aspects, sending the first route refresh message to the other node causes at least one of the other node to update a data structure of the other node to indicate that the node does not support the AFI/SAFI, the other node to initiate a local route cleanup process on the other node for the node's routes associated with the AFI/SAFI, or the other node to send, to the node, one or more route update messages that withdraw the other node's routes associated with the AFI/SAFI.

In a sixth aspect, alone or in combination with one or more of the first through fifth aspects, process 900 includes at least one of sending, to the other node and based on sending the first route refresh message, one or more route update messages that withdraw the node's routes associated with the AFI/SAFI, or initiating, based on sending the first route refresh message, a local route cleanup process on the node for the node's routes associated with the AFI/SAFI.

In a seventh aspect, alone or in combination with one or more of the first through sixth aspects, process 900 includes receiving, from the other node and based on sending the first route refresh message, one or more route update messages that withdraw the other node's routes associated with the AFI/SAFI.

Although FIG. 9 shows example blocks of process 900, in some implementations, process 900 includes additional blocks, fewer blocks, different blocks, or differently arranged blocks than those depicted in FIG. 9. Additionally, or alternatively, two or more of the blocks of process 900 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations.

As used herein, traffic or content may include a set of packets. A packet may refer to a communication structure for communicating information, such as a protocol data unit (PDU), a service data unit (SDU), a network packet, a datagram, a segment, a message, a block, a frame (e.g., an Ethernet frame), a portion of any of the above, and/or another type of formatted or unformatted unit of data capable of being transmitted via a network.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors to: perform X; perform Y; and perform Z,” that claim should be interpreted to mean “one or more processors to perform X; one or more (possibly different) processors to perform Y; and one or more (also possibly different) processors to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A node, comprising:
one or more memories; and
one or more processors to:
generate a first route refresh message associated with a border gateway protocol (BGP) session that includes a message subtype field that indicates an action request for an address family identifier (AFI) and subsequent address family identifier (SAFI) (AFI/SAFI) within the BGP session; and
send the first route refresh message to another node.

2. The node of claim 1, wherein the message subtype field indicates an addition action request for the AFI/SAFI, and
wherein the one or more processors are to send the first route refresh message to the other node to cause at least one of:
the other node to update a data structure of the other node to indicate that the node supports the AFI/SAFI, or
the other node to send, to the node, a second route refresh message that identifies the AFI/SAFI.

3. The node of claim 1, wherein the message subtype field indicates an addition action request for the AFI/SAFI, and
wherein the one or more processors are further to:
receive, from the other node and based on sending the first route refresh message, a second route refresh message that identifies the AFI/SAFI.

4. The node of claim 3, wherein the one or more processors are further to at least one of:
send, to the other node and based on receiving the second route refresh message, another route refresh message requesting advertisement of the other node's routes associated with the AFI/SAFI; or
send, to the other node and based on receiving the second route refresh message, one or more route update messages that advertise the node's routes associated with the AFI/SAFI.

5. The node of claim 3, wherein the one or more processors are further to:
receive one or more route update messages that advertise the other node's routes associated with the AFI/SAFI.

6. The node of claim 1, wherein the message subtype field indicates a deletion action request for the AFI/SAFI, and
wherein the one or more processors are to send the first route refresh message to the other node to cause at least one of:
the other node to update a data structure of the other node to indicate that the node does not support the AFI/SAFI;
the other node to initiate a local route cleanup process on the other node for the node's routes associated with the AFI/SAFI; or
the other node to send, to the node, one or more route update messages that withdraw the other node's routes associated with the AFI/SAFI.

7. The node of claim 1, wherein the message subtype field indicates a deletion action request for the AFI/SAFI, and
wherein the one or more processors are further to at least one of:
send, to the other node and based on sending the first route refresh message, one or more route update messages that withdraw the node's routes associated with the AFI/SAFI; or
initiate, based on sending the first route refresh message, a local route cleanup process on the node for the node's routes associated with the AFI/SAFI.

8. The node of claim 1, wherein the message subtype field indicates a deletion action request for the AFI/SAFI, and
wherein the one or more processors are further to:
receive, from the other node and based on sending the first route refresh message, one or more route update messages that withdraw the other node's routes associated with the AFI/SAFI.

9. A non-transitory computer-readable medium storing a set of instructions, the set of instructions comprising:
one or more instructions that, when executed by one or more processors of a node, cause the node to:
receive, from another node, a first route refresh message associated with a border gateway protocol (BGP) session that includes a message subtype field that indicates an action request for an address family identifier (AFI) and subsequent address family identifier (SAFI) (AFI/SAFI) within the BGP session; and
update, based on the action request, a data structure of the other node to indicate that the other node supports or does not support the AFI/SAFI.

10. The non-transitory computer-readable medium of claim 9, wherein the one or more instructions, when executed by the one or more processors, further cause the node to:
send, based on receiving the first route refresh message, a second route refresh message that identifies the AFI/SAFI.

11. The non-transitory computer-readable medium of claim 9, wherein the one or more instructions, when executed by the one or more processors, further cause the node to:
send, to the other node and based on receiving the first route refresh message, one or more route update messages that advertise the node's routes associated with the AFI/SAFI.

12. The non-transitory computer-readable medium of claim 9, wherein the one or more instructions, when executed by the one or more processors, further cause the node to at least one of:
initiate, based on receiving the first route refresh message, a local route cleanup process on the node for the other node's routes associated with the AFI/SAFI; or
send, to the other node and based on receiving the first route refresh message, one or more route update messages that withdraw the node's routes associated with the AFI/SAFI.

13. A method, comprising:
generating, by a node, a first route refresh message that indicates an action request for an address family identifier (AFI) and subsequent address family identifier (SAFI) (AFI/SAFI); and
sending, by the node, the first route refresh message to another node.

14. The method of claim 13, wherein sending the first route refresh message to the other node causes at least one of:
the other node to update a data structure of the other node to indicate that the node supports the AFI/SAFI, or
the other node to send, to the node, a second route refresh message that identifies the AFI/SAFI.

15. The method of claim 13, further comprising:
receiving, from the other node and based on sending the first route refresh message, a second route refresh message that identifies the AFI/SAFI.

16. The method of claim 15, further comprising at least one of:
sending, to the other node and based on receiving the second route refresh message, another route refresh message requesting advertisement of the other node's routes associated with the AFI/SAFI; or
sending, to the other node and based on receiving the second route refresh message, one or more route update messages that advertise the node's routes associated with the AFI/SAFI.

17. The method of claim 15, further comprising:
receiving one or more route update messages that advertise the other node's routes associated with the AFI/SAFI.

18. The method of claim 13, wherein sending the first route refresh message to the other node causes at least one of:
the other node to update a data structure of the other node to indicate that the node does not support the AFI/SAFI;
the other node to initiate a local route cleanup process on the other node for the node's routes associated with the AFI/SAFI; or
the other node to send, to the node, one or more route update messages that withdraw the other node's routes associated with the AFI/SAFI.

19. The method of claim 13, further comprising at least one of:
sending, to the other node and based on sending the first route refresh message, one or more route update messages that withdraw the node's routes associated with the AFI/SAFI; or
initiating, based on sending the first route refresh message, a local route cleanup process on the node for the node's routes associated with the AFI/SAFI.

20. The method of claim 13, further comprising:
receiving, from the other node and based on sending the first route refresh message, one or more route update messages that withdraw the other node's routes associated with the AFI/SAFI.
